(19) United States
(12) Patent Application Publication
(10) Pub. No.: US 2008/0145810 A1
(43) Pub. Date: Jun. 19, 2008

(54) CAP COVER

(75) Inventors: Chun-Lin Chen, Taichung City (TW); Ching-Wen Tsai, Hsinchu County (TW); Shih-Wei Chia, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: POWERCHIP SEMICONDUCTOR CORP., Hsinchu (TW)

(21) Appl. No.: 11/609,909

(22) Filed: Dec. 13, 2006

(51) Int. Cl. F27D 5/00

(52) U.S. Cl. 432/253

(57) ABSTRACT

A cap cover suitable for a furnace for semiconductor process is provided. The furnace includes a plurality of injectors and a base, and the cap cover is disposed on the base of the furnace. The cap cover includes a circular plate and an outer ring. The outer ring is disposed on the outer edge of the circular plate and extends upward from a surface of the circular plate not facing the base. The outer ring has a gap, and the gap is sufficient to accommodate the injectors.

### BACKGROUND OF THE INVENTION

1. Field of the Invention

The present invention relates to components of a semiconductor machine, and more particularly to a cap cover suitable for a furnace for semiconductor process.

2. Description of Related Art

FIG. 1 is a schematic view of a conventional furnace.

Referring to FIG. 1, a film forming reaction chamber is defined by the inner walls of an outer tube 102 of a furnace 100. An inner tube 104 is disposed in the outer tube 102, a boat 106 is disposed inside the inner tube 104, and an outer tube mount 108 is disposed at the bottom of the outer tube 102. Injectors 110 enter the furnace 100 from the outer tube mount 108. A base 114 is used to carry the boat 106, and a cap cover 112 is disposed on the base 114.

When the boat 106 feeds a wafer into the furnace 100 to process, as the specific gas used in the furnace 100 tends to attach to the base 114, the cap cover 112 is required to isolate the specific gas from the base 114, so as to prevent the specific gas from attaching to the base 114.

FIG. 2 is a schematic view of a conventional cap cover. FIG. 3 is a cross-section view of a conventional cap cover and injectors.

Referring to FIG. 2 and FIG. 3, the cap cover 112 includes a circular plate 112a and an outer ring 112b disposed on the outer edge of the circular plate 112a. The outer ring 112b has a plurality of adjacent gaps 116. When the base 114 rises to feed the boat 106 into the furnace 100, the gaps 116 may be used to accommodate the injectors 110, so as to prevent the injectors 110 from being pinched off by the cap cover 112 when the base 114 rises.

However, as for the design of the cap cover 112, the gaps 116 for accommodating the injectors 110 are not large enough. Moreover, as the material of the cap cover 112 is quartz, the volume of the cap cover 112 may become thinner after several times of wet cleaning, and may be shifted due to touch. Therefore, when the boat 106 is carried into the furnace 100, the outer ring 112b of the cap cover 112 may pinch off the injectors 110.

When the injectors 110 are pinched off, the injectors 110 are replaced with new injectors. Therefore, an adjustment of parameters and process environment, a test for gas leakage, several times of cleaning, a test for the cleanliness in the furnace 100, and a test for determining whether the thickness of a formed film is stable must be performed on the furnace 100, wherein all the above adjustments and checks may increase the whole process time.

In the conventional art, in order to prevent the shift of the cap cover 112 from pinching off the injectors 110, the shift of the cap cover 112 is checked and adjusted. However, when checking and adjusting the shift, the boat 106 must be carried into the furnace 100, and then carried out of the furnace 100 after completing the check and adjustment of the shift, which is quite time consuming.

Moreover, the check and adjustment of the shift of the cap cover 112 must be performed on non-preferable spaces and angles, and the heat in the film forming reaction chamber tends to hurt the operators during the adjustment of the cap cover 112.

### SUMMARY OF THE INVENTION

The present invention is directed to a cap cover, which may not pinch off the injectors when carrying a boat into a furnace.

The present invention is further directed to a cap cover, which requires merely checking whether the cap cover is fixed after being mounted, instead of checking and adjusting the shift of the cap cover.

The present invention provides a cap cover suitable for a furnace for semiconductor process. The furnace has a plurality of injectors and a base, and the cap cover is disposed on the base of the furnace. The cap cover comprises a circular plate and an outer ring. The outer ring is disposed on the outer edge of the circular plate, and extends upward from a surface of the circular plate not facing the base. The outer ring has a gap, and the gap is sufficient to accommodate the injectors.

According to a preferred embodiment of the present invention, two end points of the gap are respectively separated from two outermost injectors by a first distance and a second distance.

According to a preferred embodiment of the present invention, the angle formed by the two end points of the gap and the central point of the circular plate is 54°-58°.

According to a preferred embodiment of the present invention, the circular plate has an opening at the center, and the cap cover further comprises an inner ring disposed on the outer edge of the opening and extending upward from the surface of the circular plate not facing the base.

According to a preferred embodiment of the present invention, the circular plate, the outer ring and the inner ring are integrally formed.

According to a preferred embodiment of the present invention, the circular plate and the outer ring are integrally formed.

According to a preferred embodiment of the present invention, the material of the cap cover comprises quartz.

The present invention provides a cap cover suitable for a furnace for semiconductor process. The furnace has an injector and a base, and the cap cover is disposed on the base of the furnace. The cap cover comprises a circular plate and an outer ring. The outer ring is disposed on the outer edge of the circular plate, and extends upward from a surface of the circular plate not facing the base. The outer ring has a gap, and the gap is sufficient to accommodate the injector. The two end points of the gap are respectively separated from the injector by a first distance and a second distance.

The cap cover provided by the present invention cuts the plurality of adjacent gas on the conventional cap cover to form a large gap, and thus the possibility of pinching off the injector may be effectively reduced. Moreover, as the injector may not be pinched off, the cost for replacing the injector is saved, and the time for resetting and testing the furnace due to the replacement of the injector is also avoided.

In another aspect, as there is no worry about pinching off the injector by the cap cover of the present invention, and therefore only checking of whether the cap cover is fixed after being mounted is required. Thus, the process of checking and adjusting the shift of the cap cover as in the case of the prior art described above may be effectively reduced. As such, the time for checking and adjusting the shift of the cap cover is saved, and the operators are protected from being hurt by the heat in the furnace that would otherwise occur when performing the process of checking and adjusting the shift of the cap cover.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is a schematic view of a conventional furnace.

FIG. 2 is a schematic view of a conventional cap cover.

FIG. 3 is a cross-section view of a conventional cap cover and injectors.

FIG. 4 is a schematic view of a furnace according to an embodiment of the present invention.

FIG. 5 is a schematic view of cap cover according to an embodiment of the present invention.

FIG. 6 is a cross-section view of a cap cover and injectors according to an embodiment of the present invention.

FIG. 7 is a cross-section view of a cap cover and an injector according to another embodiment of the present invention.

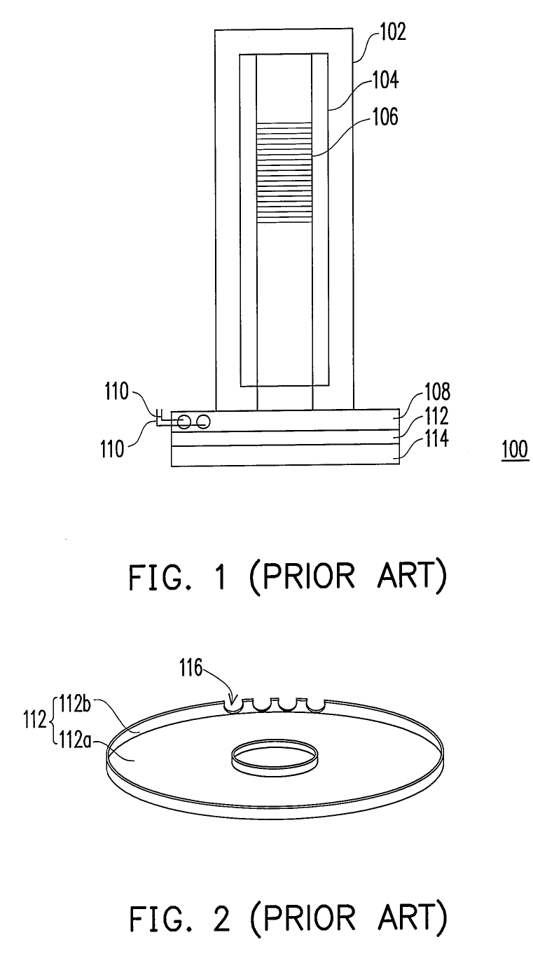

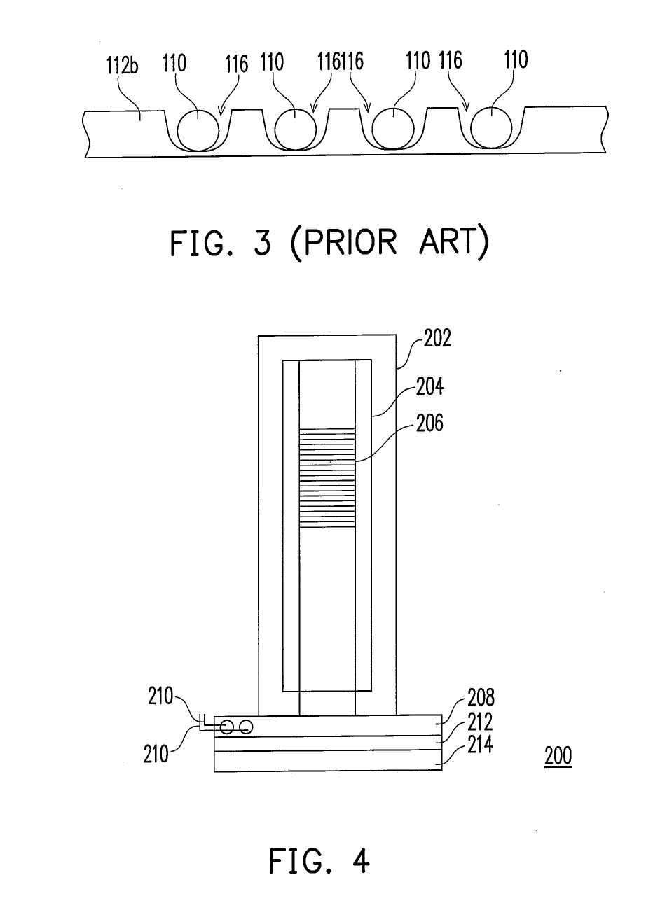

### DESCRIPTION OF EMBODIMENTS

FIG. 4 is a schematic view of a furnace according to an embodiment of the present invention.

Referring to FIG. 4, the furnace 200 includes an outer tube 202, an inner tube 204, a boat 206, an outer tube mount 208, a plurality of injectors 210, a cap cover 212 and a base 214.

A film forming reaction chamber is defined by the inner walls of the outer tube 202 of the furnace 200, the outer tube mount 208 is disposed at the bottom of the outer tube 202, and the inner tube 204 is disposed in the outer tube 202. The boat 206 is disposed in the inner tube 204, for carrying a wafer. The injectors 210 enter the furnace 200 from the outer tube mount 208, for feeding a reacting gas into the film forming reaction chamber of the furnace 200. The base 214 is used to carry the boat 206, and the base 214 is, for example, a boat elevator. The cap cover 212 is disposed on the base 214 of the furnace 200, for isolating the reacting gas from the base 214.

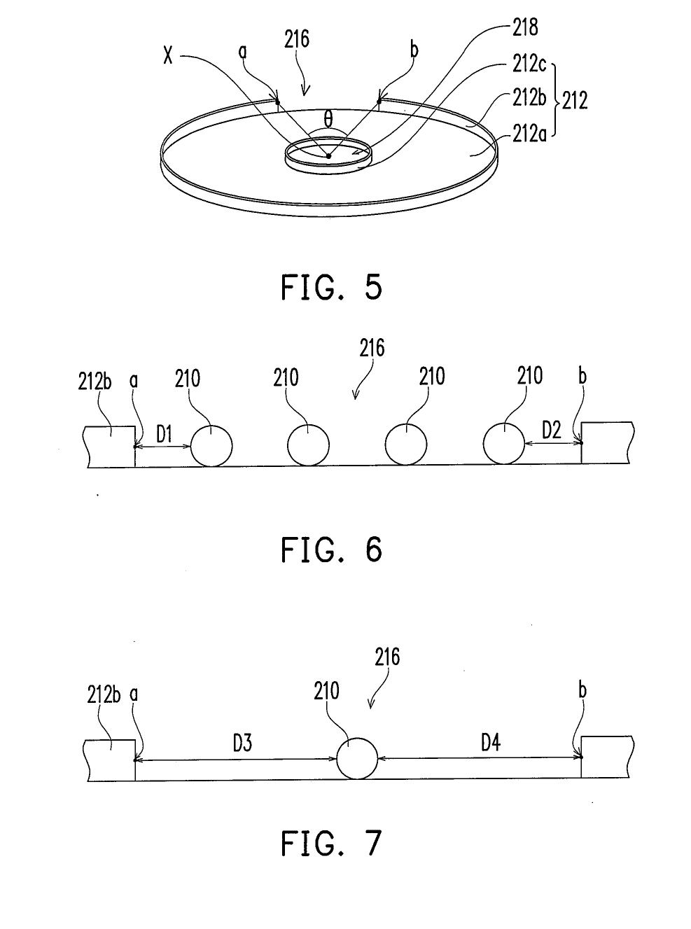

FIG. 5 is a schematic view of a cap cover according to an embodiment of the present invention. FIG. 6 is a cross-section view of a cap cover and injectors according to an embodiment of the present invention.

Referring to FIG. 4 and FIG. 5, the cap cover 212 of the present invention is suitable for the furnace 200 for semiconductor process, and the cap cover 212 is disposed on the base 214 of the furnace 200. The cap cover 212 includes a circular plate 212a and an outer ring 212b. The circular plate 212a and the outer ring 212b are, for example, integrally formed. The material of the cap cover 212 is, for example, quartz.

The outer ring 212b is disposed on the outer edge of the circular plate 212a, and extends upward from a surface of the circular plate 212a not facing the base 214. The outer ring 212b has a gap 216, and the gap 216 is sufficient to accommodate the injectors 210. The angle Θ formed by the two end points a, b of the gap 216 of the outer ring 212b and the central point x of the circular plate is, for example, 54°-58°, and preferably 56°.

Moreover, the circular plate 212a has an opening 218 at the center, and the opening 218 is used to, for example, dispose a boat rotation system (not shown) therein. The cap cover 212 further includes an inner ring 212c disposed on the outer edge of the opening 218 and extending upward form a surface of the circular plate 212a not facing the base 214. The inner ring 212c is, for example, integrally formed with the circular plate 212a and the outer ring 212b.

Referring to FIG. 6, the two end points a, b of the gap 216 of the outer ring 212b are respectively separated from two outermost injectors 210 by a distance D1 and a distance D2. The distance D1 is, for example, 0.5 cm-1.5 cm, and preferably 1 cm. The distance D2 is, for example, 0.5 cm-1.5 cm, and preferably 1 cm.

FIG. 7 is a cross-section view of a cap cover and an injector according to another embodiment of the present invention.

Referring to FIG. 5 and FIG. 7, in another embodiment of the present invention, the cap cover 212 of the present invention is also suitable for a furnace having only one injector 210. In the cap cover 212, the two end points a, b of the gap 216 of the outer ring 212b are respectively separated from the injector 210 by a distance D3 and a distance D4. The distance D3 is, for example, 9 cm-10.5 cm, and preferably 9.7 cm. The distance D4 is, for example, 9 cm-10.5 cm, and preferably 9.7 cm.

In view of the above, the cap cover 212 comprises adjacent gaps large gap 216 enough to reduce the possibility of pinching off of the injector 210 by the cap cover 212 when the boat 206 is carried into the furnace 200.

In addition, the two end points a, b of the gap 216 are respectively separated from the injector 210 by a distance, and thus the possibility of pinching off of the injector 210 by the cap cover 212 may be effectively reduced.

Moreover, as the injector 210 may not be pinched off, the cost for replacing the injector 210 is saved, and the time for resetting and testing the furnace 200 due to the replacement of the injector 210 is also avoided.

In another aspect, as the injector 210 may not be pinched off by the cap cover 212, and therefore only checking of whether the cap cover 212 is fixed after being mounted is required, and therefore the process checking and adjusting the shift of the cap cover 212 as required in the conventional art may be effectively avoided. Therefore, the time for checking and adjusting the shift of the cap cover 212 is saved, and the operators are protected from being hurt by the heat in the furnace 200 that would otherwise occur when performing the process of checking and adjusting the shift of the cap cover 212.

In view of the above, the present invention has at least the following advantages:

1. The cap cover provided by the present invention may not pinch off the injectors when the boat is carried into the furnace.

2. As the cap cover provided by the present invention may not pinch off the injectors, the cost for replacing the injectors is saved, and the time for resetting and testing the furnace due to the replacement of the injectors is also avoided.

3. The cap cover of the present invention is capable of avoiding checking and adjusting the shift as required in the conventional art.

4. As it is not required to check and adjust the shift of the cap cover of the present invention, the operators are protected from being hurt by the heat in the furnace that would otherwise occur when performing checking and adjusting the shift of the cap cover.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A cap cover, suitable for a furnace for semiconductor process, the furnace having a plurality of injectors and a base, the cap cover being disposed on the base of the furnace, comprising:
a circular plate; and
an outer ring, disposed on an outer edge of the circular plate and extending upward from a surface of the circular plate not facing the base, wherein the outer ring has a gap, and the gap is sufficient to accommodate the injectors.

2. The cap cover as claimed in claim 1, wherein the two end points of the gap are respectively separated from two adjacent outermost injectors by a first distance and a second distance.

3. The cap cover as claimed in claim 1, wherein the angle formed by two end points of the gap and a central point of the circular plate is 54°-58°.

4. The cap cover as claimed in claim 1, wherein the circular plate has an opening at the center, and the cap cover further comprises an inner ring disposed on the outer edge of the opening and extending upward from the surface of the circular plate not facing the base.

5. The cap cover as claimed in claim 4, wherein the circular plate, the outer ring and the inner ring are integrally formed.

6. The cap cover as claimed in claim 1, wherein the circular plate and the outer ring are integrally formed.

7. The cap cover as claimed in claim 1, wherein the material of the cap cover comprises quartz.

8. A cap cover, suitable for a furnace for semiconductor process, the furnace having an injector and a base, the cap cover being disposed on the base of the furnace, comprising:
a circular plate; and
an outer ring, disposed on an outer edge of the circular plate and extending upward form a surface of the circular plate not facing the base, wherein the outer ring has a gap, the gap is sufficient to accommodate the injector, and two end points of the gap are respectively separated from the injector by a first distance and a second distance.

9. The cap cover as claimed in claim 8, wherein the angle formed by two end points of the gap and a central point of the circular plate is 54°-58°.

10. The cap cover as claimed in claim 8, wherein the circular plate has an opening at the center, and the cap cover further comprises an inner ring disposed on an outer edge of the opening and extending upward from the surface of the circular plate not facing the base.

11. The cap cover as claimed in claim 10, wherein the circular plate, the outer ring and the inner ring are integrally formed.

12. The cap cover as claimed in claim 8, wherein the circular plate and the outer ring are integrally formed.

13. The cap cover as claimed in claim 8, wherein the material of the cap cover comprises quartz.
